(19) United States
(12) Patent Application Publication
(10) Pub. No.: US 2006/0225332 A1
(43) Pub. Date: Oct. 12, 2006

(54) Luggage tampering detection system

(76) Inventor: Robert F. Zenisek, Racine, WI (US)

Correspondence Address: ROBERT F. ZENISEK, 41 E. CAMPUS CT, RACINE, WI, 53402, US

(21) Appl. No.: 11/084,944

(22) Filed: Mar. 21, 2005

(51) Int. Cl. G09F 3/10

(52) U.S. Cl. 40/638

(57) ABSTRACT

A Luggage Tampering Detection System to detect unauthorized opening of airline passenger's checked luggage. This system's Tamper Detection Kit consists of specially made Security Labels and paper wrapped metal twist ties which would enable a passenger to seal both hard-sided and soft-sided luggage. Soft-sided luggage zippers would be tied together using the twist ties and the Security Labels would be signed by the passenger and then affixed to the twisted twist ties. On hard-sided luggage the signed Security Labels would be affixed over the bags openings and its latches or locks.

### BACKGROUND

1. Field of Invention

The present invention relates to tampering detection devices and security seals and specifically to passenger's checked luggage when traveling on airplanes. It is directed to prevent and detect unauthorized opening of passenger's luggage.

2. Description of Prior Art

Luggage is most often provided with either latches that lock on hard-side bags or holes in the zippers or slide fasteners tabs on soft-sided bags to insert a locking device. Passengers have been locking their luggage for many, many years. However, since the Transportation Security Administration (TSA) has started to screen all checked luggage, they are suggesting that all passengers should leave their luggage unlocked so that any bag that appears suspicious can easily be examined without damaging the latches or cutting locks. This presents airline passengers with a dilemma, should they lock their luggage and risk having their bags damaged or their locks cut; or should they leave their bags unlocked and take a chance that they will not be tampered with. Since the TSA has suggested that all luggage remain unlocked, there have been thousand of complaints of luggage tampering; many of which have never been resolved. Unlocked luggage is always going to be a temptation for petty thieves.

Protection and detection of luggage tampering is not a new problem, in fact, U.S. Pat. No. 1,472,381 to O. M. Bangs (Oct. 30, 1923) describes a seal reenforced with a thin metal strip to be cemented to luggage in transit and not in the traveler's possession. This device would be an expensive way to seal a bag given that the airline passenger's bags will normally be only out of their possession for, at most, several hours. And, it does not address the problem of how to secure soft-sided bags; which happen to be the majority of the luggage handled by the airlines.

Another attempt to provide insurance against unauthorized opening of boxes or other containers is the U.S. Pat. No. 2,013,299 to J. A. Byrne (Sept. 3, 1935) which describes a specially designed gummed label that is signed by an authorized person. While this invention was to be used by accountants to seal audit material, it could have also been used on luggage. However, the label is rather large and its unique shape would preclude its use on soft-sided luggage closed by using slide fasteners. Also, it is constructed using a multilayer approach which would required a special manufacturing process and tooling resulting in high unit cost.

Most recently, several more attempts have been made to address the luggage tampering problem. U.S. Pat. No. 5,551,729 to B. R. Morgan (Sept. 3, 1996) shows a multilayer label which provides a space for the signature of the bag's owner. This label has two marketing defects, first its construction requires the deposition of many layers of material to provide the tamper indicating layer, and the applying of a special material to receive the signature imprint. This alone would make the label costly for a one time use. Secondly, the label is designed to be placed across a flat surface; which would make it difficult to use with slide fasteners. Also, applying the label to a non flat surface would most likely cause the tampering layer to be comprised in the application process.

Another approach to provide a seal for both hard-sided and soft-sided luggage is described in U.S. Pat. No. 5,560,657 to B. R. Morgan (Oct. 1, 1996) which shows a tamper indicating label with an area for one's signature and a tongue that is designed to be used with both soft-sided bags with zippers and hard-sided bags where it can secured across the opening by using two specially designed eyelets to engage the label's tongue. While the author claims that the label would be relatively inexpensive, the design indicates that the manufacturing processes would not allow it to be. Also, the need to use separate eyelets to secure hard-sided bags across their opening makes the device more complicated for the user and is one more factor to discourage passengers to use it.

A further approach to provide tamper indication using a label is shown in U.S. Pat. No. 5,893,587 to K. H. Wong (Apr. 13, 1999), where a large label bearing the passenger's signature is used to provide both tamper indication and a receipt. The label is split into two or more parts and only a portion of the label is used to seal the bag. This approach is based on the premise that the tamper would prepare a new label and forge the passenger's signature. In the normal handling of airline luggage, anyone attempting to tamper with a bag would probably not have sufficient time and/or material to forge one's signature. Most likely, given the shortage of time available to the potential tampers, most thefts would not be a planned event. In addition, this type of label would not be easily applicable to slide fasteners or zippers on soft-sided luggage.

U.S. Pat. No. 6,343,819 to S. Shiozaki (Feb. 5 2002) shows a security tag or seal of molded plastic material that is capable of being threaded through eyelets or holes then sealed; and carries a two part identification card bearing the same serial number on each part. One part is removed after the tag is applied and serves as a receipt or identification of ownership. While the device would be quite effective on soft-sided luggage it isn't applicable to hard-sided luggage. In addition, since it is made of molded plastic, it would be very costly; especially since adding the unique serial number to it would most likely require a secondary manufacturing operation.

A Patent Application U.S. 2002/0038744 A1 filed Sep. 24, 2001 by I. Sukoff and published Apr. 4, 2002 also shows a device that appears to look like a standard cable tie with an attached “flag” to which some indica could be included. Here again, the device would only be applicable to soft-sided bags as there is no way it could be used to seal a hard-sided bag.

Patent Applications U.S. 2003/0201893 A1 filed Apr. 24, 2003 by L. Redburn and K. F. Florek (Published Oct. 30, 2003) and U.S. 2004/0164564 A1 filed Feb. 17, 2004 (Published Aug. 26, 2004) reveal a Security Fastener and Method of Securing Luggage based on using an I.D. tag applied using a special fastening gun like apparatus to secure slide fasteners or zippers on soft-sided luggage. This device could be used by the Airlines if they were required by law to secure all luggage. However, its use by the general public would be cost prohibited, and it could not be used on hard-sided luggage.

U.S. Pat. No. 6,667,091 to E. De Lima Castro Netto (Dec. 23, 2003) shows a device which is very similar to standard cable tie in appearance and usage. It also has a unique feature to incorporate a strip of paper with unique indica. The paper is fed through the mold as the tie is being made using a special molding technique. This device is only applicable to soft sided luggage and the manufacturing process requires the creation of the paper strip before molding the tie. As a result, the tie would not be inexpensive.

U.S. Pat. No. 6,694,655 to L. Redburn and K. F. Florek (Feb. 24, 2004) shows a cable tie type of device with an opening to receive a unique label for specific owner identification. While this item is applicable to any luggage employing slide fasteners, it can not be applied to any hard-sided luggage.

A detailed examination of the patents listed above and many others, reveals that there are many solutions to luggage tampering and detection; but none of the above solutions are currently being marketed to travelers. However, in looking through many travel related catalogs, one device was found specifically for passengers luggage. It is a plastic device called PrivaSeals which is sold through the Magellan Catalog. It has a plastic padlock shape with a thin locking member that one threads through the holes in the zipper tabs on soft-sided bags and then forces it into a locking hole on the body of the seal. Each seal has unique number making in impossible to forge. However, this seal is only applicable to soft-sided bags and is not inexpensive. In addition, one would have to record the serial number of each seal to be sure that they were not replace by a tamper. To open the seal, one would have to cut the thin locking member; which means the passenger would have to have the means to cut it.

In a search of the Internet for tamper detection and protection devices being marketed by travel related companies several devices were found that specifically address the problem of airline luggage tampering. Some of the more significant ones are: Tamperseal (marketed through tamperseal.com), Magellan's new Luggage Seal (which is based on the cable tie approach), Hellermanntyton Tyton Co's. Travel Ties ( which are essentially colored standard cable ties), ITW's Tamper Evident Luggage Seals ( These too are essentially cable ties) and CCTV which makes a wide variety of cable tie like devices. All of these have one thing in common, they are only applicable to luggage using side fasteners or zippers; they can not be used with hard-sided bags and all require the passenger to record all the serial numbers ( when they have them ) to be sure that they haven't been replaced.

Another other item found on the Internet was a sealing tape marketed by CGM Security Solutions which is a special tape that could be used to secure boxes and hard-sided bags. When the tape was removed, a message appeared that said “Opened”. Again, while this would work on hard-sided bags it would not be applicable for bags using side fasteners or zippers.

Also found on the Internet is a device called “Nanoseal” which is an electronic device which will record the each time a bag is opened, both the date and time of the day and the time of the intrusion. It is supposed to good for 1000 seals. However, an intrusion wouldn't necessarily be evident until you opened the bag; for it is placed in the bag and it has a very high price tag.

Another device being marketed specifically for hard-sided luggage with standard locks is a bag strap called “Flight-Tight” found in the Magellan Catalog. It essentially is plastic strap that is wrapped around the bag and is secured in such a manner that the strap must be cut to open the bag. Here, again the traveler is faced with carrying something “sharp” to cut the strap on arrival.

Lastly, new combination locks called “Travel Sentry”, also found in the Magellan Catalog and elsewhere, have been certified by the TSA. These locks are designed to be opened by the TSA using a special key so the lock does not have to be cut if the TSA needs to inspect a bag's contents. Again, these locks are of no value on hard-sided luggage.

### SUMMARY OF PRIOR ART

Looking at the universe of luggage tampering detection devices currently available or previously revealed, indicates that while there are many solutions to the problem all of them have at least one or more marketing defects that make a better solution apparent. Some of these are as follows:
1. Most of the solutions above address either soft-sided luggage or hard-sided luggage. The only solution that addressed both types of luggage required the use of special “eyelets” to allow the sealing of a hard-sided case. This alone would discourage most travelers. Besides, this solution is currently not available on the market.
2. The solutions that are essentially based on the cable tie approach usually provide a serial number on the device. Most soft-sided luggage has at least two zippers and sometimes three. Thus requiring the passenger to record several numbers to be sure that someone hasn't substituted one of their own for the passenger's. Remember, that these devices are available to anyone and if the tamper replaces one of the passenger's seals with another one of the same type and color, it most likely would not be discovered unless the traveler carefully checked the serial number.
3. The devices that are “in effect” cable ties are made of plastic and many are difficult to cut when the passenger needs to open the bag. Similar devices used by the TSA to secure bags after opening them are extremely difficult to cut open. If the passenger's main or only bag is “sealed” with one of these devices, one has to carry in their hand luggage something to cut the seal; like a nail clipper or a small knife. However, the TSA has confiscated these in many cases.
4. Putting a unique serial number on the cable tie types of seals most often requires a secondary operation after the molding and increases the cost of the device. . Even the solution that has the serial number card that can be removed (S. Shiozaki U.S. Pat. No. 6,343,819) would require the passenger keep a small piece of plastic to verify that the seal has not been substituted.
5. Most of the “label type” of devices are multilayered which would require an expensive manufacturing process and are not suited for sealing soft-sided bags with their many zippers. Applying a multilayered label to a zipper pair would most likely cause to layers to fracture and compromise the integrity of the label. Others are too large to effectively seal the slide fasteners or zippers.
6. The TSA certified combination locks require a special key to open them without them knowing the combination. The plan is that only the employees of the TSA would have the key. By now, its more than likely that copies of these keys are already in the public domain. Any clever locksmith could purchase some of the locks and replicate the keys to be sold to any potential thief Also, the TSA certified locks cannot be used on hard-sided luggage as they are designed to lock slide fasteners or zippers.
7. There is an increase use of hard-sided luggage because with the use of newer, lighter materials which reduce the weight of the bags and the addition of wheels which makes them much easier to handle. Also, they do a better job of keeping the passengers clothing wrinkle free which is very desirable. The TSA certified locks cannot be used on the locks on these bags. The only currently available device good for securing hard-sided luggage is the “Flight Tight” strap which also must be cut to open the bag.

### OBJECTIVES AND ADVANTAGES OF THE PRESENT INVENTION

The problem of luggage tampering detection is one that every airline passenger faces today. It will not go away in the near future. Many travelers are not sophisticated and would appreciate a simple and inexpensive way to detect any tampering with their luggage. They are not likely to spend at lot of money for a system they hope isn't needed. Or, in case of the infrequent traveler, one that is costly and is used only once.

Luggage tampers are most likely of two type, the opportunistic type who sees a bag that they may think has something of value in it and just open it; and the premeditated type who are planning to tamper with bags and have acquired a variety of seals to substitute for the passenger's when they actually open a bag. They may have also illegally obtained keys to the TSA certified locks. Discussions with former airline employees suggest that most tampering occurs with luggage transferred between airlines or interline transfers. Without the ability to lock their bags, passengers will always be susceptible to luggage tampering; their only hope is for easy and accurate detection of the tampering

Therefore, what is required is low cost, easy to use system, that airline passengers' can use to seal their bags and instantly know whether or not their bag has been opened. And, in addition, the passenger can be absolutely sure that no one has tampered with their luggage without the necessity of recording serial numbers of their seals. Plus, the sealing itself should not require any cutting when the passenger needs to open their bags upon arrival. It must be simple system, but also highly reliable that provides positive proof of the seal's integrity. Lastly, the system must accommodate both hard-sided and soft-sided bags with equal ease. It must provide for sealing hard-sided luggage in such a manner that the locks or the case will not be damaged if the case must be opened, yet indicate that the bag has been opened.

### SUMMARY OF THE PRESENT INVENTION

The preferred embodiment of the Luggage Tampering Detection System consists of a set of specially made pressure sensitive paper labels with a high tack adhesive which would be compromised when they are removed from the luggage and paper wrapped metal twist ties of sufficient length/size to allow the securing of slide fastener or zipper tabs. The special labels and twist ties would be packaged as a “Tampering Detection Kit”. A traveler would write their signature or some other indica on the special labels and when sealing hard-sided bags would place one or more labels over the bag's opening edges and/or locks/latches which would prevent opening the bags without cutting or disturbing the labels. When sealing soft-sided luggage, the traveler would use the paper wrapped metal twist tie to fasten the zipper tabs together and then affix a signed label to the twisted twist tie to preventing removing the twist tie without disturbing the label.

With one's luggage sealed as described above, a passenger could quickly determine whether or not their bag has been tampered with. Because each label bears the passenger's signature or some other special indica, it would be extremely difficult for any tamper to quickly reproduce it given the fairly short time they would most likely have available to them. Even if time were available, forging a signature is not an easy task. To make the task even more difficult for the forger, each set of labels could have a special serial number and would be in two parts, one part providing a copy for the passenger's records. Thus, any tamper would not only have to forge the passenger's signature, but would have to duplicate the printing of the serial number which was preprinted on the label.

The labels could be colored, printed with a background LOGO or some other message that made them somewhat unique and difficult to reproduce easily, even a Company's LOGO. Also, the labels could be made with weakened breakaway sections or microcuts, similar to those used on many pricing labels, that would cause them to come apart if anyone tried to remove them after they were affixed to the bags or the twist ties. The serial numbered type would constructed so that when each signed label was removed from the carrier, a portion would remain on it for the passenger's record. Lastly, the adhesive used on the labels could also be of the permanent type such that removing them would cause them to be damaged or destroyed.

This combination of a twist tie and a label would serve to effectively seal all types of luggage at a very low cost. Passengers with hard-sided luggage would not have to lock their bags to ensure that their bags have not been opened and their bags locks would not have to be forced opened by TSA to examine them. Passengers with soft-sided luggage would not have to search for a tool to cut a seal upon arrival and would not have to record a set of serial numbers. And, once the labels have been, applied TSA would know the luggage has not been tampered with since it left the passenger's care.

### BRIEF DESCRIPTION OF THE DRAWINGS

FIG. 1 is a perspective view in elevation of the preferred embodiment of the invention as applied to securing the slide fasteners or zippers on a soft-sided piece of luggage to create a tamper detecting seal.

FIG. 2 is a perspective view in elevation of the preferred embodiment of the invention as applied to securing the locks and opening of a hard-sided piece of luggage creating the tamper detection seals.

FIG. 3 is a perspective view in elevation of the preferred embodiment of the invention showing how a twist tie is used to secure the slide fasteners or zippers on a piece of soft-sided luggage prior to applying the tamper detection seal.

FIG. 4 is a plane view of a set of labels used on the preferred embodiment.

FIG. 5 is a plane view of a set of twist ties used on the preferred embodiment.

FIG. 6 is a plane view of a set of serial numbered labels used on the preferred embodiment.

FIG. 7 is a plane view of a set of serial numbered labels showing the label carrier after several labels have been removed.

FIG. 8 is a plane view of a single signed label prior to its attachment to either a hard-sided piece of luggage or to a twist tie securing the zippers on a piece of soft-sided luggage.

FIG. 9 is a plane view of a single signed serial numbered label prior to its attachment to either a hard-sided piece of luggage or the twist tie securing the zippers on a soft-sided bag.

FIG. 10 is a plane view of single twist tie used on the preferred embodiment.

### REFERENCE NUMBERS IN THE DRAWINGS

10 Typical soft-sided bag zipper closing.

11 Typical hard-sided piece of luggage.

12 Set of unsigned Security Labels mounted on typical carrier.

13 Set of typical paper wrapped wire twist ties.

14 Set of unsigned serial numbered Security Labels mounted on typical carrier.

15 Unsigned serial numbered Security Labels left on carrier along with the reference portion of used Labels.

16 Signed Security Label prior to sealing hard sided luggage or zipper openings.

17 Signed serial numbered Security Label prior to sealing hard sided luggage or zipper openings.

18 Single paper wrapped twist tie.

20 Signed serial numbered Security Label tamper detecting seal.

21 Single paper wrapped metal twist tie securing zipper tab openings.

22 Twisted portion of twist tie wrapped through zipper tab openings.

23 Zipper tab openings.

24 Hard sided luggage case opening.

25 Hard sided luggage lock.

26 Signed Security Label affixed over luggage lock creating a tamper detection seal.

27 Signed Security Label affixed over hard sided luggage case opening creating a tamper detection seal.

28 Typical Label carrier with Security Labels.

29 Single Security Label.

30 Signature portion of a single serial numbered Security Label.

31 Reference portion of a single serial numbered Security Label.

32 Traveler's signature written on a Security Label.

33 Paper wrapping around metal core of twist tie.

34 Metal core of twist tie

### DESCRIPTION OF THE PREFERRED EMBODIMENT

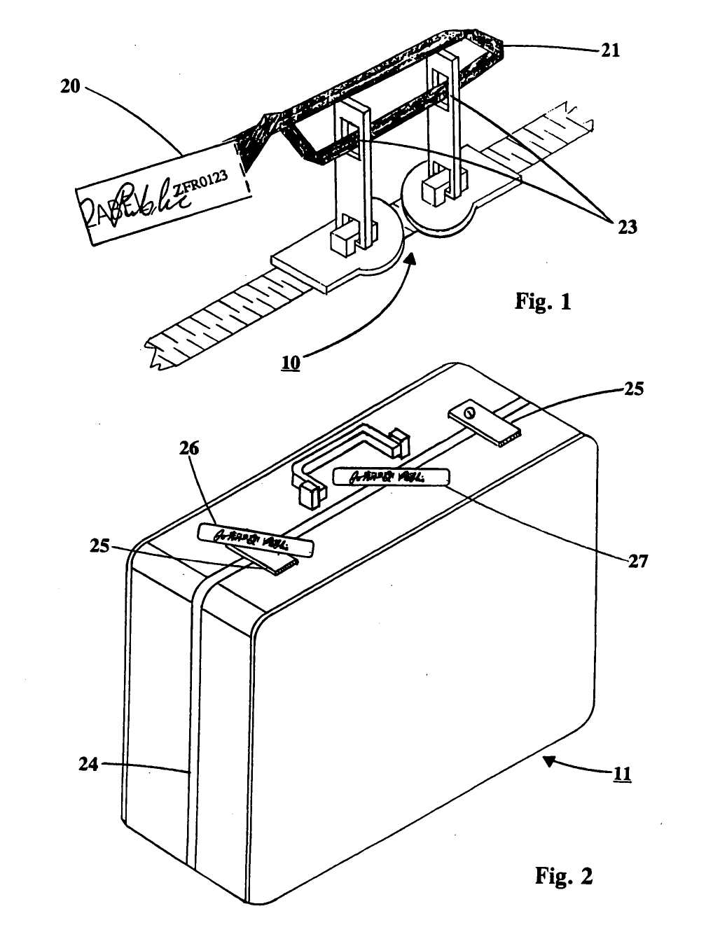

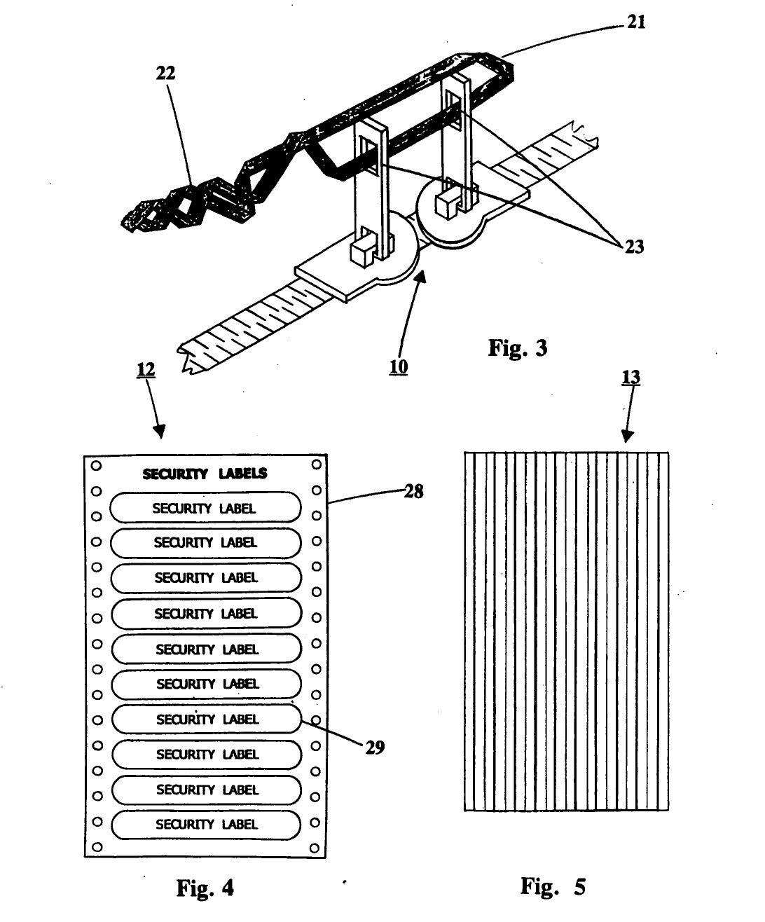

FIGS. 1 and 3 of the drawings illustrate how the present invention can combine a twist tie and a special type of label to create a tamper detecting seal on a typical soft-sided bag zipper closing 10. FIG. 3 shows how a paper wrapped metal twist tie 18 is bent and twisted 21 thru the zipper tab openings 23 and the ends of the twist tie are further twisted to provide a secure seal 22 of the zipper tabs. Then as shown in FIG. 1, a signed serial numbered Security Label 17 is folded and affixed over the twisted portion of the twist tie 22 resulting in the Security Label covering and sealing the twist tie creating 20, the tamper detection seal.

FIG. 2 illustrates how a hard-sided piece of luggage 11 would be sealed using signed Security Label 16 to seal the luggage's opening 24 and it's locks/latches 25. A signed Security Label 16 is affixed over one of the bag's locks, 25 resulting in a tamper detection seal 26. Another signed Security Label 16, is affixed across the bag's opening 24 to create a second tamper detection security seal 27 thus providing additional protection.

FIG. 4 of the drawings show a set of Security Labels 12 comprised of a label carrier 28 with a set of Security Labels 29 mounted on it prior to their being signed.

FIG. 5 of the drawings shows a set of paper wrapped metal core twist ties 13 which together with the Security Labels in FIG. 4 make up a Luggage Tampering Detection Kit.

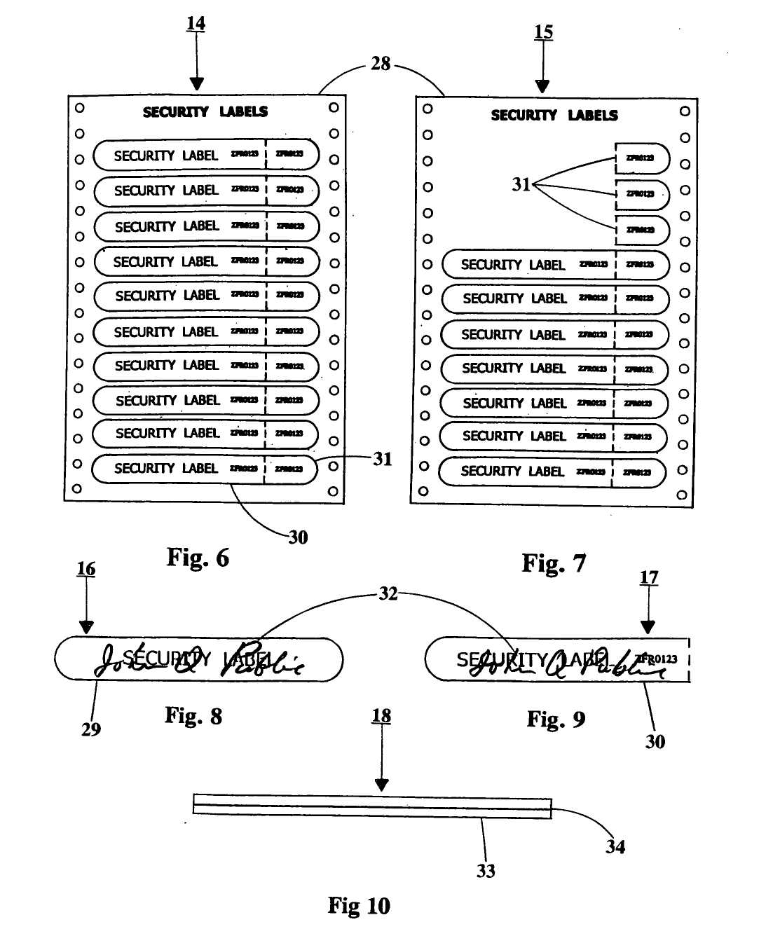

FIG. 6 illustrates how a set of serial numbered Security Labels 14, comprised of a label carrier 28 and a set of unsigned serial numbered signature portion Security Labels 30 and their reference portion, 31 mounted on the carrier 28 would provide an alternate more secure version of the labels used in the Luggage Tampering Detection Kit.

FIG. 7 shows how the label carrier set 15, would retain the reference portion 31 of the serial numbered labels on the label carrier 28 after the signature portion of the label 30 has been signed and removed from the carrier to create 17 a tampering detecting label which is used to seal the luggage. The label carrier set 15 could then be placed with the passengers other documents for easy reference and verification and for future use.

FIG. 8 shows how a Security Label 29 signed with the traveler's signature 32, can make a tamper detection seal 16, to be used to seal the traveler's luggage.

FIG. 9 shows how the signature portion of a serial numbered Security Label 30, signed with the traveler's signature 33 can make a tamper detection seal 17 to be used to seal the travelers luggage.

FIG. 10 shows the make-up of the paper wrapping 33 surrounding the metal core 34 of the twist tie 18 used to secure the, zippers on soft sided luggage.

I claim:

1. An airline luggage tampering detection system consisting of kit containing a set of specially made pressure sensitive labels and twist ties.

2. The kit as set forth in claim 1 wherein said pressure sensitive labels are made of paper and are of sufficient size and shape to allow the owner of said luggage to write their signature or some special indica on them prior to affixing them to said luggage.

3. The kit as set forth in claim 1 wherein the said pressure sensitive labels are mounted on a carrier and have sufficiently high tack or adhesive to cause them to be compromised when said labels are removed from said luggage.

4. The kit as set forth in claim 1 wherein the said pressure sensitive labels have plurality of perforations and/or microcuts which would cause said labels to be damaged or destroyed when said labels are removed from said luggage.

5. The kit as set forth in claim 1 wherein said pressure sensitive labels may be printed with a special serial number and be in two parts such that a reference portion of said label containing a copy of the serial number would remain on said carrier after said label has been signed and affixed to the said luggage.

6. The kit as set forth in claim 1 wherein said pressure sensitive labels may be colored and may be printed with some specific indica to identify them as security labels.

7. The kit as set forth in claim 1 wherein the said twist ties would be paper wrapped with a metal core and be of sufficient length and diameter to accommodate securing the pull tab openings on the zippers of soft-sided luggage.

8. An airline Luggage Tampering Detection Kit providing for the unique personal identification of the evidence of opening or tampering of a passenger's luggage by using the passenger's signature or some other personalized indica on specially made pressure sensitive labels and twist ties to seal the openings on the passenger's luggage.
